(19) United States
(12) Patent Application Publication
(10) Pub. No.: US 2017/0071392 A1
(43) Pub. Date: Mar. 16, 2017

(54) COOKING DEVICE

(71) Applicant: Panasonic Intellectual Property Management Co., Ltd., Osaka (JP)

(72) Inventors: AKIRA KATAOKA, Shiga (JP); MASAKI SHIBUYA, Osaka (JP)

(21) Appl. No.: 15/122,635

(22) PCT Filed: Jun. 15, 2015
(86) PCT No.: PCT/JP2015/002971

§ 371 Date: Aug. 30, 2016

(30) Foreign Application Priority Data
Jun. 18, 2014 (JP) 2014-125188

(51) Int. Cl. A47J 27/04; H05B 6/64

(52) U.S. Cl. CPC A47J 27/04; H05B 6/6479

(57) ABSTRACT

A cooking device includes food container having food and food spaces in food, and a bottom of food container is provided with openings. The cooking device includes steam generator in its body, and steam generated from steam generator is ejected from a plurality of steam outlet ports provided in steam supply. Steam is introduced into food container through openings of food container disposed opposite to steam outlet ports, and thus food is heated by steam.

### TECHNICAL FIELD

The present invention relates to a cooking device for heating food with steam with the food being placed in a food container.

### BACKGROUND ART

Conventionally, there has been proposed a cooking device in which a prepared frozen food is thawed and cooked while packed in a container (see e.g. PTL 1).

In a conventional cooking device, however, one lip side of a cylindrical body is opened and the other lip side is provided with a bottom plate having a number of small holes, and either one of the lips is used as a steam inlet port and the other lip as a steam suction port, thus requiring a very complex structure.

### CITATION LIST

### Patent Literature

PTL 1: Unexamined Japanese Utility Model Application Publication No. S60-68071

### SUMMARY OF THE INVENTION

The present invention provides a cooking device for heating food with steam with the food being placed in a food container.

A cooking device according to a first aspect of the present invention includes a food container having a food space for receiving one or more pieces of food and an opening provided on a wall of the food container to let the food space inside the food container communicate with an outside of the food container. The cooking device also includes a steam generator for generating steam and a steam supply having a steam outlet port into which the steam generated by the steam generator is introduced. The food container and the steam generator are disposed with the steam supply therebetween. The opening is located opposite to the steam outlet port. The steam introduced into the steam outlet port enters the food container through the opening of the food container and heats the food.

### BRIEF DESCRIPTION OF DRAWINGS

FIG. 1 is a cross-sectional view illustrating a cooking device according to a first exemplary embodiment of the present invention.

FIG. 2 is a rear view of a food container of the cooking device according to the first exemplary embodiment of the present invention.

FIG. 3 is a cross-sectional view of the cooking device according to the first exemplary embodiment of the present invention, wherein food in the food container is frozen rice.

FIG. 4 is a cross-sectional view of the cooking device according to the first exemplary embodiment of the present invention, wherein food in the food container is frozen noodles.

FIG. 5 is a cross-sectional view of a cooking device according to a second exemplary embodiment of the present invention.

FIG. 6 is a cross-sectional view of a cooking device according to a third exemplary embodiment of the present invention.

FIG. 7 is a cross-sectional view of a cooking device according to a fourth exemplary embodiment of the present invention.

FIG. 8 is a cross-sectional view of an essential part of the cooking device according to the fourth exemplary embodiment of the present invention.

FIG. 9 is a cross-sectional view of a cooking device according to a fifth exemplary embodiment of the present invention.

### DESCRIPTION OF EMBODIMENTS

Exemplary embodiments of the present invention will now be described with reference to the drawings. These exemplary embodiments do not limit the present invention.

### First Exemplary Embodiment

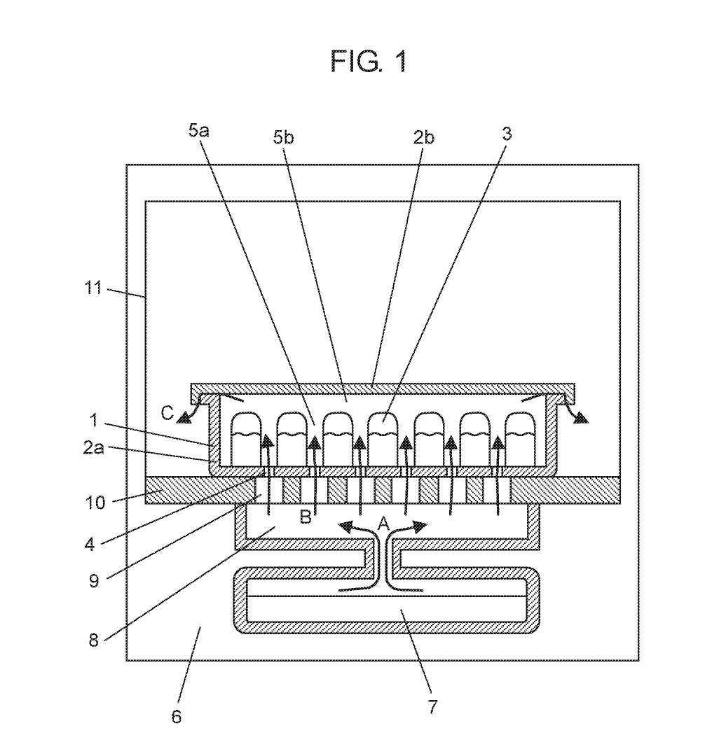

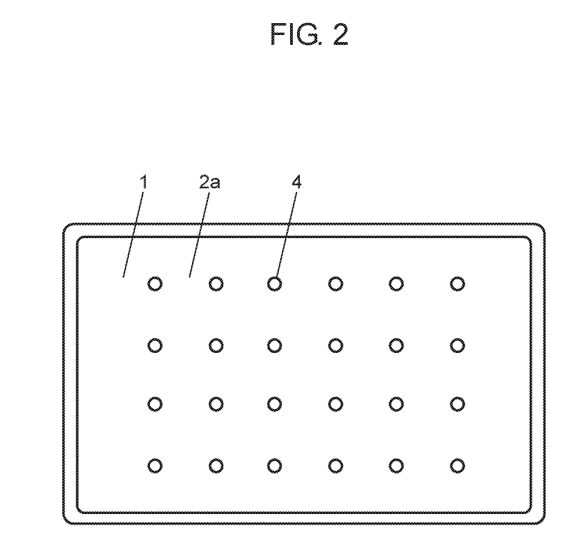

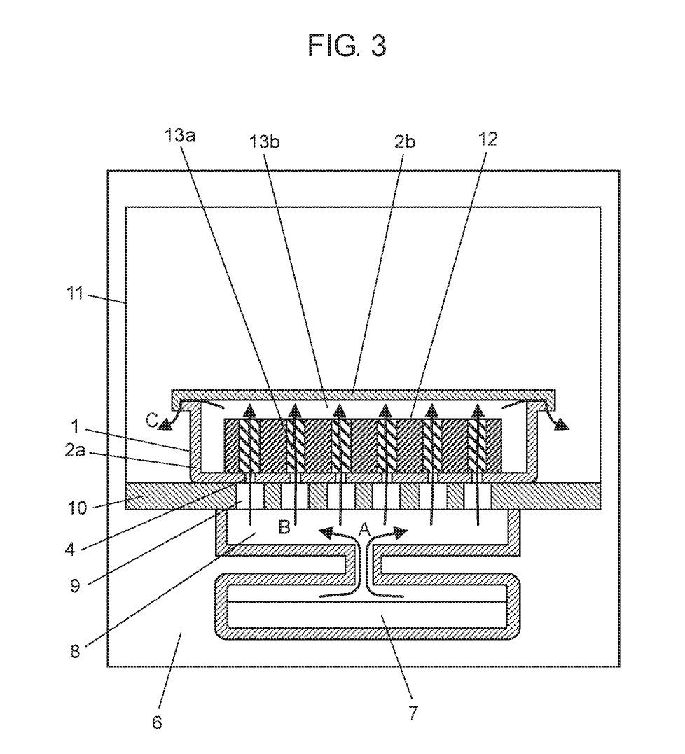

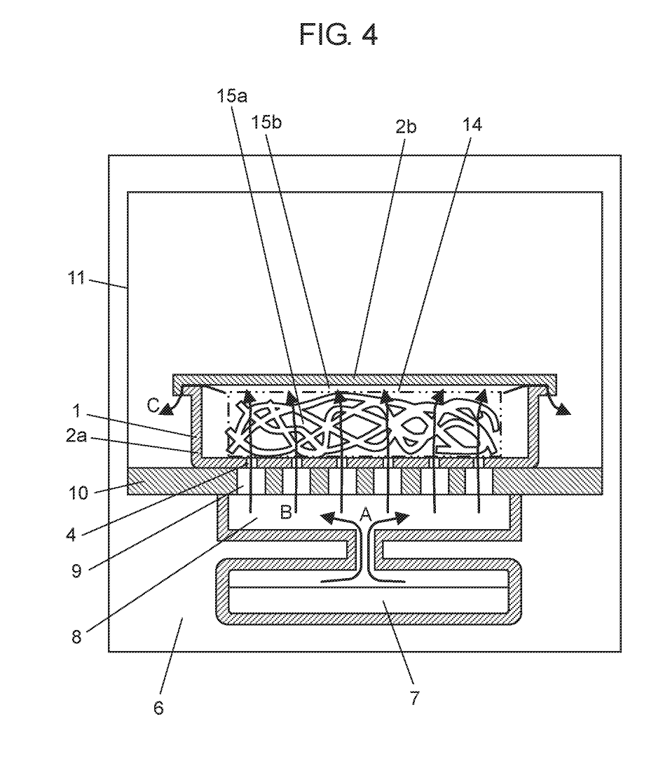

FIG. 1 is a cross-sectional view illustrating a cooking device according to a first exemplary embodiment of the present invention. FIG. 2 is a rear view of a food container of the cooking device. FIG. 3 is a cross-sectional view illustrating the food container containing frozen rice as food in the present embodiment. FIG. 4 is a cross-sectional view illustrating the food container containing frozen noodles as food placed in the food container of the cooking device.

In FIG. 1, cooking chamber 11 disposed in cooking device body 6 has an openable cooker door (not shown) on its front. Cooking chamber 11 accommodates food container 1. Food container body 2a and food container lid 2b are made of, for example, a polypropylene resin. Food container 1 is made up of lower food container body 2a and upper food container lid 2b fitted to each other, and food container 1 has pieces of food 3 such as, for example, dumplings therein. The bottom of food container 1 is provided with openings 4.

There are provided food space 5a between pieces of food 3 and food space 5b between pieces of food 3 and the inner walls of food container body 2a and food container lid 2b. At least part of food space 5a communicates with the exterior of food container 1 through openings 4. A plurality of openings 4 in the bottom of food container 1 are arranged as illustrated in FIG. 2.

A lower portion of cooking device body 6 is provided with steam generator 7. Steam generator 7 includes a heating unit (not shown), such as a heater, and this heating unit is driven to heat water in steam generator 7 to generate steam.

The bottom of cooking chamber 11 is provided with planar steam supply 10 made of a polypropylene resin. Steam supply 10 has steam outlet ports 9. This steam outlet port is a hole larger than opening 4 of food container 1. Steam generated in steam generator 7 passes through steam diffuser 8 and is ejected from a plurality of steam outlet ports 9 into food container 1. The bottom of food container 1 having openings 4 is disposed opposite to steam outlet ports 9 of steam supply 10.

The operation and effect of the cooking device configured as above are described below.

As illustrated in FIG. 1, the bottom of food container 1 having openings 4 is disposed opposite to steam outlet ports 9 of steam supply 10 in cooking chamber 11. When steam generator 7 is driven, the heating unit heats water in steam generator 7 to generate steam. Steam generated passes through steam diffuser 8 as indicated by arrows A in the drawing and reaches openings 4 of food container 1 through the plurality of steam outlet ports 9 as indicated by arrows B. Thereafter, steam fills food spaces 5a, 5b of food container 1 through openings 4, and thus food 3 can be easily heated by steam.

Steam outlet port 9 larger than opening 4 allows opening 4 to face steam outlet port 9 even if food container 1 is somewhat misaligned.

Steam diffuser 8 is intended to uniformly and stably distribute steam to the plurality of steam outlet ports 9. If steam pressure in food container 1 is high, depending on the state of fullness of the steam, part of the steam is discharged from a gap between food container body 2a and food container lid 2b as indicated by arrows C.

Heating is carried out for a predetermined period of time in accordance with food 3 in food container 1. Accordingly, only steam generator 7 is needed, and a complex structure, such as a conventional steam suction device, is not required. Also, when prepared food cooked by heating is served to a customer in restaurants, food 3 is packed in food container 1 in advance and a clerk can handle food 3 without direct touch, resulting in the food being served with clean and easy handling.

Additionally, when steam introduced into food container 1 is condensed, the steam turns into water droplets and they are drained to food container 1 through openings 4, but the water droplets are returned to steam diffuser 8 through steam outlet ports 9, thereby preventing the water droplets from remaining in steam supply 10.

Furthermore, when fine-granular frozen food 12 such as, for example, frozen rice is packed in food container 1, food space 13a made up of a plurality of communication holes is provided in advance in food 12 to be frozen as illustrated in FIG. 3, and food 12 is solidified by freezing, for example, in a generally rectangular solid, rather than being simply packed in food container 1. The food, such as frozen rice, includes frozen rice, frozen steamed sticky rice, and frozen pilaf.

Food space 13b is also provided between food 12 and the walls of food container body 2a and food container lid 2b. Accordingly, food spaces 13a, 13b are filled with steam, thus facilitating heating of frozen food 12. Of course, if food 12 has gaps therein through which steam passes even if food 12 is frozen rice or the like, these gaps define the food space and food spaces 13a, 13b may be omitted.

When frozen noodles or the like is packed in food container 1, a plurality of food spaces 15a through which steam passes are formed in advance in frozen food 14 as illustrated in FIG. 4, and food 14 is solidified by freezing, for example, in a generally rectangular solid, rather than being simply packed in food container 1. At least part of food spaces 15a communicates with openings 4.

Food 14, such as frozen noodles, includes frozen “Udon” (wheat noodles), frozen “Soba” (buckwheat noodles), frozen “Ramen” (Chinese noodles), and frozen pasta. Food space 15b is also provided between food 14 and the walls of food container body 2a and food container lid 2b. Accordingly, food spaces 15a, 15b are filled with steam, thus facilitating heating of frozen food 12. Of course, since food spaces 15a allow steam to flow around food 14, food space 15b may be omitted.

Moreover, since food container 1 is accommodated in cooking chamber 11 and is used for cooking, the walls of cooking chamber 11 and the cooking door prevent steam from leaking out of body 6 so that the steam can safely leak from food container 1.

### Second Exemplary Embodiment

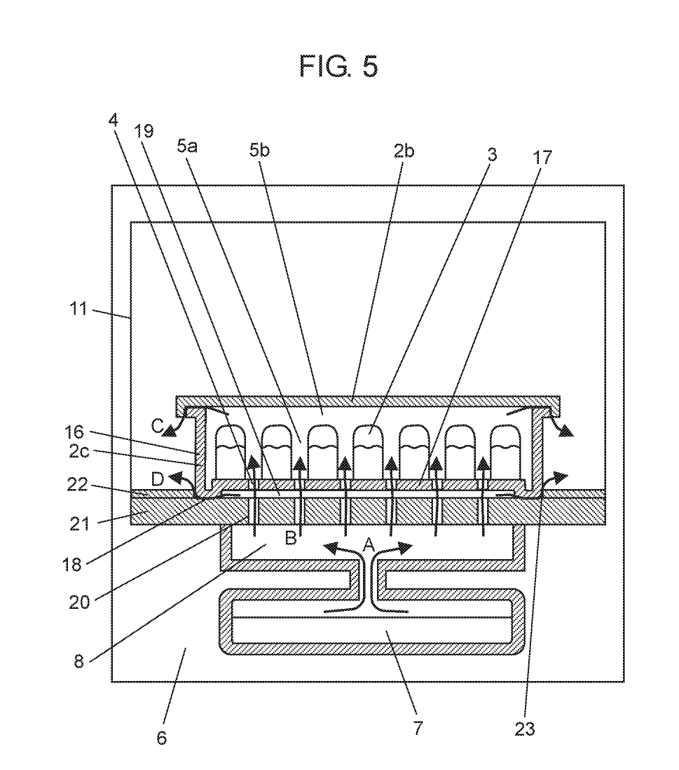

FIG. 5 is a cross-sectional view illustrating a cooking device according to a second exemplary embodiment of the present invention.

In FIG. 5, food container lid 2b, food 3, openings 4, food spaces 5a, 5b, body 6, steam generator 7, steam diffuser 8, and cooking chamber 11 are identical to those described in the first exemplary embodiment, so that the same reference numerals and reference designations are used and descriptions thereof are omitted.

In FIG. 5, food container 16 is made up of lower food container body 2c and upper food container lid 2b fitted to each other. The central portion of the bottom of food container body 2c is provided inwardly with concave portion 17, and the entire outer periphery of the bottom is provided with mounting portion 18. Mounting gap 19 is therefore formed at the bottom of food container 16. Openings 4 are formed in concave portion 17, food 3 is put on the top of concave portion 17, food space 5a is provided between pieces of food 3 and food space 5b is provided between pieces of food 3 and the inner walls of food container body 2c and food container lid 2b, and at least part of food space 5a communicates with openings 4.

Steam generated from steam generator 7 is ejected from a plurality of steam outlet ports 20 through steam diffuser 8. Steam outlet ports 20 are formed in planar steam supply 21 made of, for example, a polypropylene resin, and steam supply 21 is secured to the bottom of cooking chamber 11 disposed in body 6.

A plate-like projection, designated by reference numeral 22 and is made of, for example, a polypropylene resin, is removably attached to the top of steam supply 21, and has open rectangular hole 23 therein. Rectangular hole 23 is located on the outer periphery of steam outlet ports 20. The front of cooking chamber 11 is provided with a cooking door (not shown). By placing food container 16 in rectangular hole 23 of projection 22, steam outlet ports 20 of steam supply 21 and openings 4 of food container 16 are disposed opposite to each other, and food container 16 is ready to be heated.

The operation and effect of the cooking device configured as above is described below.

With food container 16 disposed as shown in FIG. 5, steam generator 7 is driven to generate steam. This steam is ejected from steam outlet ports 20 as indicated by arrows B through steam diffuser 8 as indicated by arrows A, and fills food spaces 5a, 5b of food container 16 through openings 4 of food container 16, and thus food 3 can be easily heated by steam. Steam diffuser 8, which stabilizes steam pressure therein, can uniformly and stably distribute steam to steam outlet ports 20. If steam pressure in food container 16 is high, depending on the fitting state between food container body 2c and food container lid 2b and/or the state of fullness of the steam, part of the steam is discharged from between food container body 2c and food container lid 2b as indicated by arrows C.

The basic operation is as described above, and the present exemplary embodiment provides the following advantages. By simply fitting food container 16 in rectangular hole 23 of projection 22, steam outlet ports 20 of steam supply 21 and openings 4 of food container 16 can be easily disposed opposite to each other, thereby improving usability. Since this prevents food container 16 from being misaligned, steam outlet port 20 needs not be larger than opening 4, and the degree of freedom of design is increased.

By fitting food container 16 in projection 22, steam can be prevented from leaking from a gap between mounting portion 18 of food container 16 and steam supply 21 as indicated by arrows D. Furthermore, projection 22 is configured to be removably attached to steam supply 21, so that projection 22 can easily correspond to a differently-sized food container by preparing a projection with a modified rectangular hole shape or the like.

The configuration, in which the central portion of the bottom of food container 16 is provided inwardly with concave portion 17, the entire outer periphery of the bottom is provided with mounting portion 18, and mounting gap 19 is formed at the bottom of food container 16, has the following advantages. Since the area of mounting portion 18 is small compared to the entire bottom area of food container 16, mounting portion 18 increases contact pressure and, as a result, steam can be prevented from leaking from between mounting portion 18 and steam supply 21 as indicated by arrows D.

Meanwhile, by forming mounting gap 19 at the bottom of food container 16, steam can be supplied to openings 4 open to steam through mounting gap 19 when part of the plurality of openings 4 is not likely to be open to steam, thereby stabilizing the steam supply to food container 16. Additionally, while it is contemplated that steam outlet ports 20 and openings 4 opposite to each other are somewhat misaligned if no projection 22 is provided, steam flow through mounting gap 19 complements the misalignment, and stabilizes steam flow from steam outlet ports 20 to openings 4.

Concave portion 17 formed in the bottom of food container body 2c of food container 16 increases the strength of the bottom of food container 16.

While plate-like projection 22 with rectangular hole 23 is used in the present exemplary embodiment, a plurality of rib-shaped projections may be inserted in steam supply 21. In brief, alignment of food container 16 is only needed.

### Third Exemplary Embodiment

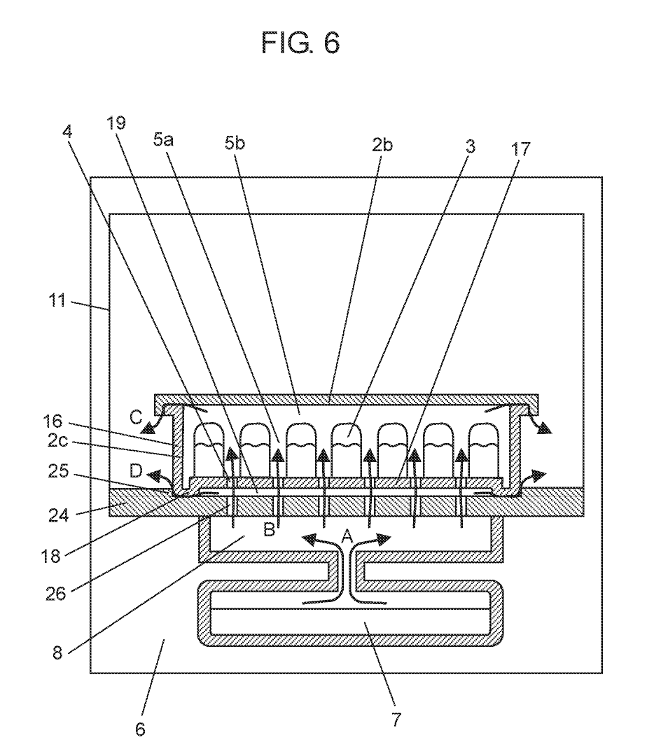

FIG. 6 is a cross-sectional view illustrating a cooking device according to a third exemplary embodiment of the present invention.

In FIG. 6, food container lid 2b, food container body 2c, food 3, openings 4, food spaces 5a, 5b, body 6, steam generator 7, steam diffuser 8, cooking chamber 11, food container 16, concave portion 17, mounting portion 18, and mounting gap 19 are identical to those described in the second exemplary embodiment, so that the same reference numerals and reference designations are used and descriptions thereof are omitted.

Steam supply 24, which is made of, for example, a polypropylene resin, is secured to the bottom of cooking chamber 11 disposed in body 6. Steam supply 24 is provided with recess 25, which includes a plurality of steam outlet ports 26 therein. The front of cooking chamber 11 is provided with a cooking door (not shown). By placing food container 16 in recess 25, steam outlet ports 26 of steam supply 24 and openings 4 of food container 16 are disposed opposite to each other, and food container 16 is ready to be heated.

The operation and effect of the cooking device configured as above is described below.

With food container 16 disposed as shown in FIG. 6, steam generator 7 is driven to generate steam. This steam is ejected from a plurality of steam outlet ports 26 as indicated by arrows B through steam diffuser 8 as indicated by arrows A, and fills food spaces 5a, 5b of food container 16 through openings 4 of food container 16, and thus food 3 can be easily heated by steam. Steam diffuser 8, which stabilizes the steam pressure therein, can uniformly and stably distribute steam to steam outlet ports 26.

If steam pressure in food container 16 is high, depending on the fitting state between food container body 2c and food container lid 2b and/or the state of fullness of the steam, part of the steam is discharged from between food container body 2c and food container lid 2b as indicated by arrows C.

The basic operation is as described above, and the present exemplary embodiment provides the following advantages.

By simply fitting food container 16 in recess 25, steam outlet ports 26 of steam supply 24 and openings 4 of food container 16 can be easily disposed opposite to each other, thereby improving usability. Since this prevents food container 16 from being misaligned, steam outlet port 26 needs not be larger than opening 4, and the degree of freedom of design is increased. By fitting food container 16 in recess 25, steam can be prevented from leaking from a gap between mounting portion 18 of food container 16 and steam supply 24 as indicated by arrows D.

### Fourth Exemplary Embodiment

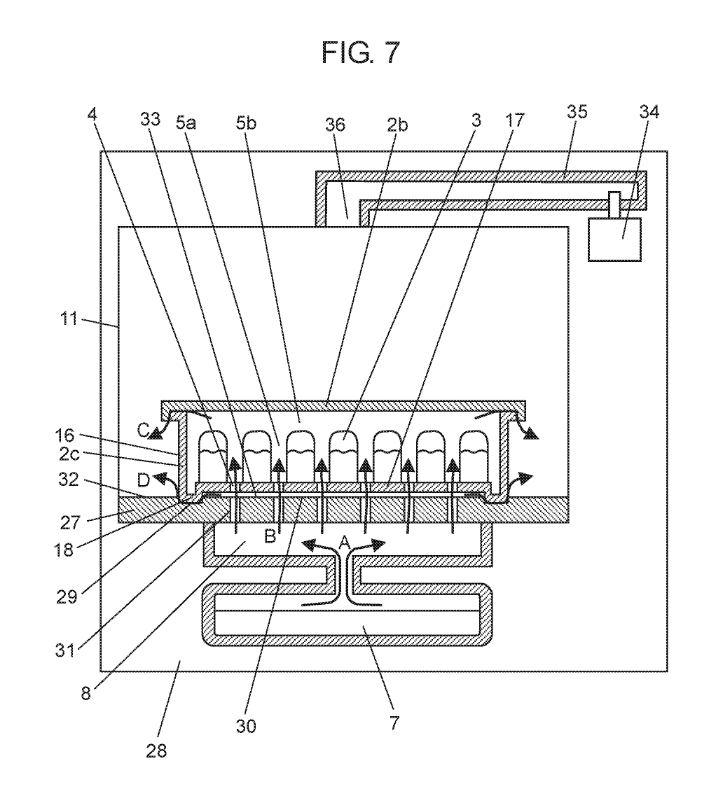

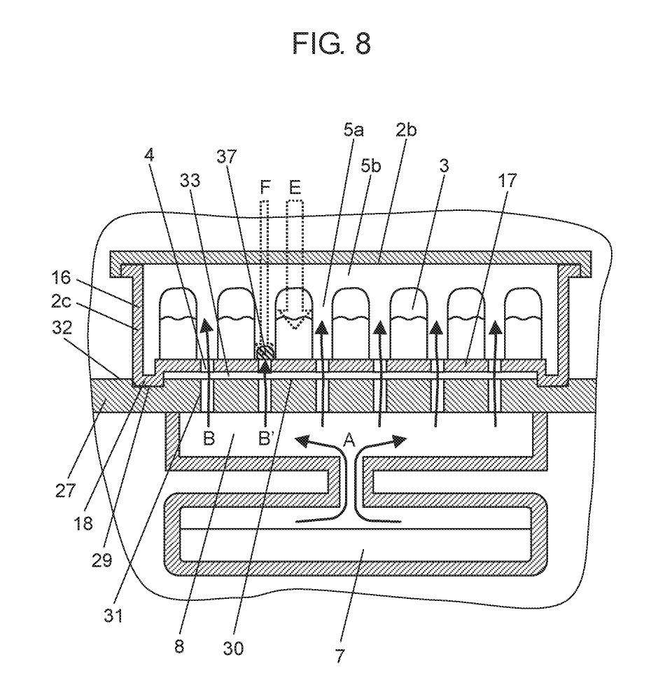

FIG. 7 is a cross-sectional view illustrating a cooking device according to a fourth exemplary embodiment of the present invention, and FIG. 8 is a cross-sectional view of an essential part of the cooking device.

In FIG. 7, food container lid 2b, food container body 2c, food 3, openings 4, food spaces 5a, 5b, steam generator 7, steam diffuser 8, cooking chamber 11, food container 16, concave portion 17, and mounting portion 18 are identical to those described in the second exemplary embodiment, so that the same reference numerals and reference designations are used and descriptions thereof are omitted.

Steam supply 27, which is made of, for example, a polypropylene resin, is secured to the bottom of cooking chamber 11 disposed in body 28. Steam supply 27 is provided with recess 29 having a groove shape slightly wider than mounting portion 18, and inner portion 30 inside groove-shaped recess 29 includes a plurality of steam outlet ports 31. Steam supply 27 is formed such that inner portion 30 inside recess 29 is as high as outer portion 32 outside recess 29. The front of cooking chamber 11 is provided with a cooking door (not shown).

By placing mounting portion 18 of food container 16 in recess 29, steam outlet ports 31 of steam supply 27 and openings 4 of food container 16 are disposed opposite to each other, and food container 16 is ready to be heated. Here, the depth of recess 29 is dimensioned such that there exists mounting gap 33 between concave portion 17 of food container 16 and inner portion 30. Microwave generator 36, which includes magnetron 34, generates microwaves from magnetron 34, and emits microwaves through waveguide 35 at the top of cooking chamber 11, is disposed in the upper portion of body 28, and heats food in cooking chamber 11 with microwaves.

The operation and effect of the cooking device configured as above is described below.

With food container 16 disposed as shown in FIG. 7, steam generator 7 is driven to generate steam. This steam is ejected from the plurality of steam outlet ports 31 as indicated by arrows B through steam diffuser 8 as indicated by arrows A, and fills food spaces 5a, 5b of food container 16 through openings 4 of food container 16, and thus food 3 can be easily heated by steam. By fitting mounting portion 18 of food container 16 in recess 29 in the outer periphery of steam outlet ports 31 of steam supply 27, steam can be prevented from leaking from a gap between mounting portion 18 of food container 16 and steam supply 27 as indicated by arrows D.

Here, by driving magnetron 34 of microwave generator 36 while driving steam generator 7, microwaves are emitted at the top of cooking chamber 11, and food 3 in food container 1 can be heated by microwaves as indicated by arrow E in FIG. 8. Food 3 is therefore heated by microwaves as well as by steam. Thus, food 3 is heated not only by steam for supplying the food surface with heat but also by microwaves for directly heating the inside of the food, thereby improving heating performance and reducing heating time.

In particular, when food 3, such as frozen dumplings, is used to extend the expiration date, the simultaneous use of steam heating and microwave heating has the following two advantages.

(1) Microwaves tend to enhance heating of water by about 2000 times compared to ice. When steam comes in contact with frozen food 3, condensation water is immediately produced on a food surface, and microwaves efficiently affect and heat the condensation water. This greatly improves heating efficiency for frozen food 3.

(2) When frozen food 3 is put in food container 16, water from ambient air, food 3, etc. turns into ice 37 (see FIG. 8), which may often adhere to openings 4 etc. of food container 16. Therefore, in the case where only steam is introduced into food container 16, ice 37 adhered to opening 4 blocks the passage of steam to frozen food 3 as indicated by arrow B′, and this portion of frozen food 3 cannot be heated by steam until ice 37 adhered to opening 4 is melted, resulting in longer heating time being needed.

However, when simultaneously heated by steam and microwaves, steam affects ice 37 that blocks opening 4. As with the effect described in the above paragraph (1), when condensation water is produced on an ice surface, microwaves mainly affect the condensation water and efficiently heat the condensation water, as indicated by arrow F in FIG. 8. By heating the condensation water, ice 33 that blocks opening 4 is melted rapidly and turned into water, which flows out through opening 4. This ensures the passage of steam, allows the frozen food to be rapidly exposed to steam, and can eliminate the trouble associated with ice 37.

Of course, even when the steam is blocked by ice 37, microwaves can also advantageously heat frozen food directly as indicated by arrow E in FIG. 8. In this manner, combined heating using both steam heating and microwave heating simultaneously has significant advantages.

Food container lid 2b, food container body 2c, and steam supply 27 are made of a polypropylene resin. The polypropylene resin itself is less likely to be heated by microwaves, is fully heat-resistant up to a temperature of about 100° C., and is optimal for these members.

Furthermore, the present exemplary embodiment, where inner portion 30 and outer portion 32 constituting steam supply 27 have the same height and the groove of recess 29 is ring-shaped when viewed from above, provides a flat structure as a whole and a specific position to place food container 16, being user-friendly and also excellent in design.

When food is simply cooked only by microwave heating in the present exemplary embodiment, in which microwave heating alone may be used, a dish or the like on which food is placed can be used while maintaining a flat condition even if the dish or the like is placed across the groove of recess 29 and on inner portion 30 and outer portion 32.

### Fifth Exemplary Embodiment

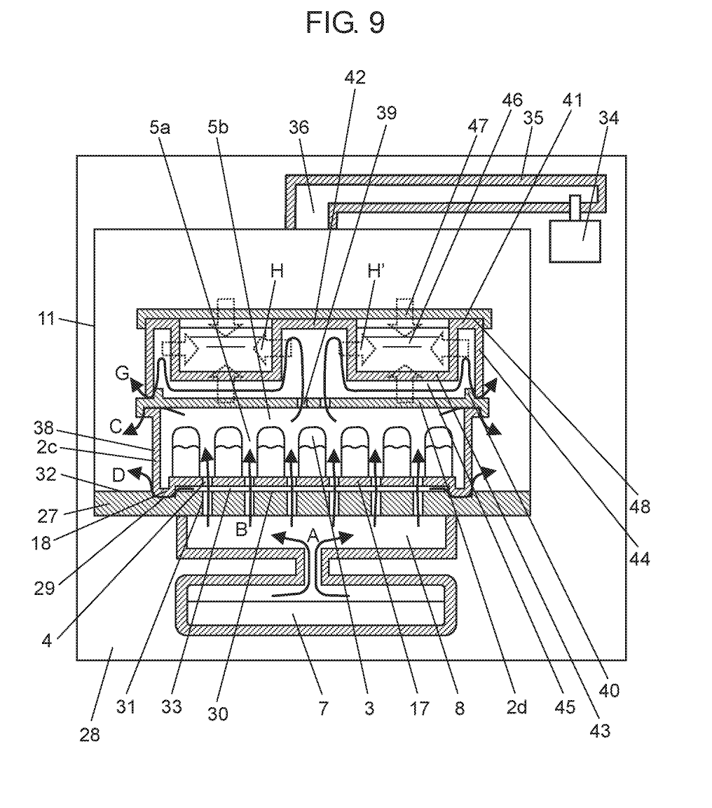

FIG. 9 is a cross-sectional view illustrating a cooking device according to a fifth exemplary embodiment of the present invention.

In FIG. 9, food container body 2c, food 3, openings 4, food spaces 5a, 5b, steam generator 7, steam diffuser 8, cooking chamber 11, concave portion 17, mounting portion 18, steam supply 27, and body 28 are identical to those described in the fourth exemplary embodiment, so that the same reference numerals and reference designations are used and descriptions thereof are omitted. Likewise, recess 29, inner portion 30, steam outlet ports 31, outer portion 32, mounting gap 33, magnetron 34, waveguide 35, and microwave generator 36 are also identical to those described in the fourth exemplary embodiment, so that the same reference numerals and reference designations are used and descriptions thereof are omitted.

Food container 38 is made up of lower food container body 2c and upper food container lid 2d fitted to each other, and food container lid 2d has steam through holes 39 in its center and protrusion 40 on its periphery. Second food container body 41 has convex container projection 42 in its center, concave container recess 43 on the periphery of container projection 42, and additionally container sidewall 44 on the outer periphery of container recess 43. Container sidewall 44 of second food container body 41 is fitted to the outer periphery of protrusion 40 of food container lid 2d and thus misalignment is prevented, at which time inter-container gap 45 is formed between second food container body 41 and food container lid 2d.

Container recess 43 can contain second food 46 such as, for example, soup. Second food container lid 47 is put on second food container body 41 and covers second food 46. Lower second food container body 41 and upper second food container lid 47 fitted to each other constitute second food container 48.

Second food container body 41 and second food container lid 47 are made of, for example, a polypropylene resin.

The operation and effect of the cooking device configured as above is described below.

With food container 38 disposed as shown in FIG. 9, steam generator 7 is driven to generate steam. This steam is ejected from the plurality of steam outlet ports 31 as indicated by arrows B through steam diffuser 8 as indicated by arrows A, and fills food spaces 5a, 5b of food container 38 through openings 4 of food container 38, and thus food 3 can be easily heated by steam.

Additionally, the steam enters inter-container gap 45 between food container lid 2d and second food container body 41 through steam through holes 39 of food container lid 2d, flows as indicated by arrows G, and heats second food 46 through the walls of second food container body 41. Since second food container body 41 is made up of convex container projection 42 and concave container recess 43 and the area exposed to steam is increased, the steam heating can be improved.

The steam mainly flows as described above, and thus a steam flow such as indicated by arrow C is reduced.

Furthermore, by driving magnetron 34 of microwave generator 36 while driving steam generator 7, microwaves are emitted from the top and bottom of cooking chamber 11, food 3 in food container 38 is heated by microwaves, and second food 46 in second food container 48 is also heated by microwaves.

However, a problem arises that, when heating a liquid with microwaves, microwave heating is concentrated on the side portion of the liquid, and the central portion thereof is less heated. The reason is that the side portion of the liquid is heated by microwaves entering from both vertical and lateral directions, while the central portion of the liquid is heated by microwaves entering only from a vertical direction and the central portion is less heated as a result.

In particular, less convection occurs in a viscous liquid, so that the phenomenon in which the central portion of the liquid is less heated is more pronounced. In the present exemplary embodiment, however, the central portion of second food container body 41 is provided with container projection 42, providing a space and allowing for microwave entry paths as indicated by dotted arrows H, H′. As illustrated in FIG. 9, second food 46 such as soup is uniformly heated from around by microwaves as shown by arrows indicating the microwave entry paths and, thus, there is no longer a problem of less heating for the central portion, and second food 46 can be heated uniformly.

In the present exemplary embodiment, the center of food container lid 2d is provided with steam through holes 39, through which steam that has once entered food container 38 is used to heat second food 46 in second food container 48. However, since second food 46 in second food container 48 can also be heated by microwaves, steam through holes 39 may be omitted.

While food container body 41 of second food container 48 is provided with container projection 42 and container recess 43 in the present exemplary embodiment, food container body 41 may have no projection or recess. Additionally, while liquid food such as soup is used as second food 46 in the present exemplary embodiment, solid food such as, for example, deep-fried food may also be used. In brief, second food 46 only needs to be heated by microwaves using microwave generator 36.

Further, while the bottom of cooking chamber 11 is configured to have steam supply 10, 21, 24 in the first to third exemplary embodiments, the configuration may be such that no cooking chamber 11 is provided and steam supply 10, 21, 24 is mounted in the upper position. In brief, it is sufficient that steam is ejected from steam outlet ports 9, 20, 26 provided in steam supply 10, 21, 24, food container 1, 16 is filled with steam through openings 4 of food container 1, 16, and food in food container 1, 16 can be heated.

While microwave generator 36 is disposed above cooking chamber 11 in the fourth and fifth exemplary embodiments, microwave generator 36 may be disposed below cooking chamber 11 or may be disposed above and below cooking chamber 11.

Still further, while food 3 is, for example, dumplings in the second to fifth exemplary embodiments, food 3 may be food 12 such as frozen rice or food 14 such as frozen noodles. In the fifth exemplary embodiment, second food 46 may be curry or the like in use of food 12 such as frozen rice, and may be Worcestershire sauce, dipping sauce, or the like in use of food 14 such as frozen noodles.

While food container 1, 16, 38 is rectangular when viewed from the top in the first to fifth exemplary embodiments, the shape of the food container is not limited thereto. For example, food container 1, 16, 38 can be round or elliptical when viewed from the top. In brief, food container 1, 16, 38 needs only be a food container capable of enclosing food 3, 12, 14. Food may be shaped according to the shape of the food container.

Furthermore, food container lid 2b, 2d is fitted to food container body 2a, 2c in the first to fourth exemplary embodiments. However, food container lid 2b, 2d may be fixed to food container body 2a, 2c with an adhesive, etc. and the food container lid may be provided with small holes for letting the interior communicate with exterior of the food container. Food container body 2a, 2c and/or food container lid 2b, 2d may be configured such that the steam escapes when the steam pressure or the temperature within the food container is above a certain level. For example, a portion of the container may be provided with a pressure relief valve or the like. In brief, it is only necessary to prevent an abnormal rise in steam pressure in the food container.

While food container 1, 16, 38 is configured such that food container lid 2b, 2d is fitted to food container body 2a, 2c in the first to fifth exemplary embodiments, the food container may be formed, for example, by forming an upper section of the food container integrally with a lower section thereof, and folding the upper section and the lower section. In brief, food 3, 12, 14 only needs to be packed in food container 1, 16, 38.

Moreover, in the first to fifth exemplary embodiments, the bottom of food container 1, 16, 38 is provided with openings 4 and openings 4 are disposed opposite to steam outlet ports 9, 20, 26, 31 of steam supply 10, 21, 24, 27, thereby introducing steam into food container 1, 16, 38. However, the configuration may be, for example, such that the top of the food container is provided with openings, the steam supply is disposed above the food container, the steam outlet ports and the openings are disposed opposite to each other, and steam is introduced into the food container. In brief, the steam outlet ports and the openings only need to be disposed opposite to each other.

As described above, a cooking device according to a first aspect of the present invention includes a food container having a food space for receiving one or more pieces of food and an opening provided on a wall of the food container to let the food space inside the food container communicate with an outside of the food container. The cooking device also includes a steam generator for generating steam and a steam supply having a steam outlet port into which the steam generated by the steam generator is introduced. The food container and the steam generator are disposed with the steam supply therebetween. The opening is located opposite to the steam outlet port. Steam introduced into the steam outlet port enters the food container through the opening of the food container and heats the food. In this manner, the opening of the food container containing food is disposed opposite to the steam outlet port of the steam supply, so that steam from the steam outlet port easily enters the food space through the opening and heats the food with steam. Accordingly, food can be heated without using a complex steam suction device or the like as used in prior art. When heating food and serving it to a customer in restaurants, etc., a food container containing food in advance only needs to be placed with the opening of the food container opposed to the steam outlet port, and thus a clerk can easily heat food by steam without directly touching food. Accordingly, a cooking device for heating food is provided that is clean and easily handled.

Preferably, in a cooking device according to a second aspect of the present invention, the steam supply is provided with a projection, and an outer wall of the food container and the projection of the steam supply are fitted to each other. Thus, the food container can be aligned with the steam supply, and the opening of the food container can be easily disposed opposite to the steam outlet port.

In a cooking device according to a third aspect of the present invention, the projection of the steam supply is preferably provided on an outer periphery of the steam outlet port. Thus, part of steam entering the food container from the steam outlet port through the opening can be prevented from leaking through an interface between the steam supply and the food container.

In a cooking device according to a fourth aspect of the present invention, the steam supply is preferably provided with a recess, and an outer wall of the food container and the recess of the steam supply are preferably fitted to each other. Thus, the food container can be aligned with the steam supply and the opening of the food container can be easily disposed opposite to the steam outlet port. Additionally, the steam supply can also be beautiful in appearance since the steam supply has only the recess and has no projection.

In a cooking device according to a fifth aspect of the present invention, the recess of the steam supply is preferably provided on an outer periphery of the steam outlet port. Thus, part of steam entering the food container from the steam outlet port through the opening can be prevented from leaking through an interface between the steam supply and the food container.

Preferably, a cooking device according to a sixth aspect of the present invention includes a microwave generator that generates microwaves and transmits the microwaves to the food container, and the food in the food container is heated by steam and also by the microwaves transmitted from the microwave generator. Thus, food is not only heated by steam for supplying a food surface with heat but also by microwaves for directly heating the inside of the food, thereby improving heating performance.

In the case where a frozen food is packed in a food container, water from ambient air, food, etc. freezes to turn into ice and blocks an opening of the food container during freezing of the food in prior art. Thus, there is a problem that food is hard to heat until ice blocking the opening melts into water, water drains from the opening, and the opening is unblocked, even if steam is introduced into the food container. However, combined heating using both steam heating and microwave heating allows the ice blocking the opening to be heated by steam and microwaves and to be melted quickly, and thus the opening can be communicated in a short period of time as compared to prior art. Even while the opening is blocked by the ice, food can be directly heated by microwaves, thereby heating food stably and quickly.

### INDUSTRIAL APPLICABILITY

As described above, a cooking device according to the present invention, which can heat food in a food container in a simple configuration and by a simple operation, is also applicable, for example, to a process of heating food in the food container in a food factory.

### REFERENCE MARKS IN THE DRAWINGS

1, 16, 38 food container
3, 12, 14 food
4 opening
5a, 5b, 13a, 13b, 15a, 15b food space
6 body
7 steam generator
9, 20, 26, 31 steam outlet port
10, 21, 24, 27 steam supply
22 projection
25, 29 recess
36 microwave generator
46 second food
48 second food container

1. A cooking device comprising:
a food container having a food space for receiving food;
an opening provided on a wall of the food container to let the food space inside the food container communicate with an outside of the food container;
a steam generator for generating steam; and
a steam supply having a steam outlet port into which the steam generated by the steam generator is introduced,
wherein the food container and the steam generator are disposed with the steam supply therebetween,
the opening is located opposite to the steam outlet port, and
the steam introduced into the steam outlet port enters the food container through the opening of the food container and heats the food.

2. The cooking device according to claim 1,
wherein the steam supply is provided with a projection, and an outer wall of the food container and the projection of the steam supply are fitted to each other.

3. The cooking device according to claim 2,
wherein the projection of the steam supply is provided on an outer periphery of the steam outlet port.

4. The cooking device according to claim 1,
wherein the steam supply is provided with a recess, and an outer wall of the food container and the recess of the steam supply are fitted to each other.

5. The cooking device according to claim 4,
wherein the recess of the steam supply is provided on an outer periphery of the steam outlet port.

6. The cooking device according to claim 1, further comprising a microwave generator that generates a microwave and transmits the microwave to the food container,
wherein the food in the food container is heated by steam and also by the microwave transmitted from the microwave generator.

7. The cooking device according to claim 2, further comprising a microwave generator that generates a microwave and transmits the microwave to the food container,
wherein the food in the food container is heated by steam and also by the microwave transmitted from the microwave generator.

8. The cooking device according to claim 3, further comprising a microwave generator that generates a microwave and transmits the microwave to the food container,
wherein the food in the food container is heated by steam and also by the microwave transmitted from the microwave generator.

9. The cooking device according to claim 4, further comprising a microwave generator that generates a microwave and transmits the microwave to the food container,
wherein the food in the food container is heated by steam and also by the microwave transmitted from the microwave generator.

10. The cooking device according to claim 5, further comprising a microwave generator that generates a microwave and transmits the microwave to the food container,
wherein the food in the food container is heated by steam and also by the microwave transmitted from the microwave generator.
